(19) United States
(12) Patent Application Publication
(10) Pub. No.: US 2007/0056800 A1
(43) Pub. Date: Mar. 15, 2007

(54) Ladder safety matt invention

(76) Inventor: Joseph Morgese, Daytona Beach, FL (US)

Correspondence Address: JOSEPH MORGESE;STE. 606, PMB 389, 1500 BEVILLE ROAD, DAYTONA BEACH, FL, 32114, US

(21) Appl. No.: 11/521,252

(22) Filed: Sep. 14, 2006

Related U.S. Application Data
(60) Provisional application No. 60/717,409, filed on Sep. 15, 2005.

(51) Int. Cl. E06C 7/42

(52) U.S. Cl. 182/107

(57) ABSTRACT

The Ladder Safety Matt Invention enhances ladder safety by using slip-resistant matts for both the bottom feet of the ladder (1) and at the area of contact to the building's surface (5) at the top. These light weight rubber products are an inexpensive way to help keep the ladder in a desired position. If on grass, earth or sand, stakes may be driven though the matt's (1) holes (2) to keep it in position. If on asphalt, concrete or wood the rubber material of the matt (1) provides traction. An extension ladder (3) would have slip-proof rubber boots (4) at the top end to both provide traction and protect the surface being leaned on. Also, elevated rubber matts (5) do the work of keeping the ladder in place by providing frictional holding power against the top surface while at the same time, providing a slip-proof area for climbing onto and back down from the surface to the ladder.

### BACKGROUND OF INVENTION

1. Field of Invention

This invention caters to ladder safety, specifically for providing additional traction and surface protection wherever ladders are used.

2. Discussion of Prior Art

Although there exists many safety products available in the marketplace today to enhance ladder safety. This Ladder Safety Matt serves as yet another method, to be used with today's ladders, as a way of enhancing their safe use even further. It is an inexpensive way to increase ladder safety.

Until now, today's common ladders could slip and slide along gutters and roof edges causing damage to them. As well, on the ground, a ladder could inadvertently slip on slick surfaces such as tiles or moisture-laden grass.

### OBJECTS AND ADVANTAGES

Accordingly, several objects and advantages of the Ladder Safety Matt Invention are:

(a) A simple set of devices, which are inexpensive and easy to use.

(b) They can be used with most any existing ladder on the market.

(c) They store away taking very minimal space.

(d) They are a lightweight and the preferred embodiment is made of soft rubber or a slip-resistant equivalent.

Further objects and advantages of my invention will become apparent from a consideration of the drawings and ensuing description.

### DESCRIPTION OF DRAWINGS

FIG. 1 Close-up of Ladder Safety Matt (ground version)

FIG. 2 Close-up of rail boots and adjoining Ladder Safety Matts (elevated surface version)

FIG. 3 Example of a Ladder Safety Matt (ground version) being used with a stepladder.

FIG. 4 Example of Ladder Safety Matts (both ground and elevated surface versions) being used with an extension ladder against a building.

### LIST OF REFERENCE NUMERALS

1—Ladder Safety Matt (ground version)
2—Holes for driving stakes into the ground
3—extension ladder
4—rail boots
5—Ladder Safety Matt (elevated surface version)
6—connecting straps
7—stepladder
8—building
9—ground
10—roof

### SUMMARY OF INVENTION

In essence, a simple, economical way to provide added safety whenever a ladder is used, by providing slip resistance at all areas where a ladder contacts surfaces.

### DESCRIPTION OF INVENTION

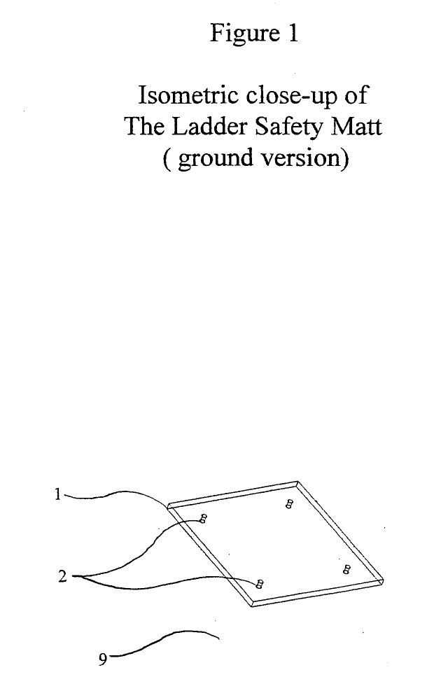

FIG. 1 shows an isometric close-up view of The Ladder Safety Matt (ground version) (1). A flat rubber matt with a plurality of holes (2), (this drawing shows four), where spikes may be driven through into the ground, should the ladder be on grassy or sandy surfaces. The quality of the rubber used for the matt indents to the weight of the ladder and the person using it causing the feet of the ladder to remain in place at the indentation, and once the ladder is removed, the rubber re-attains it's former shape.

Also, the rubber provides slip proofing on various surfaces such as concrete, asphalt, tile, carpet, linoleum etc . . . while, at the same time, protecting the flooring

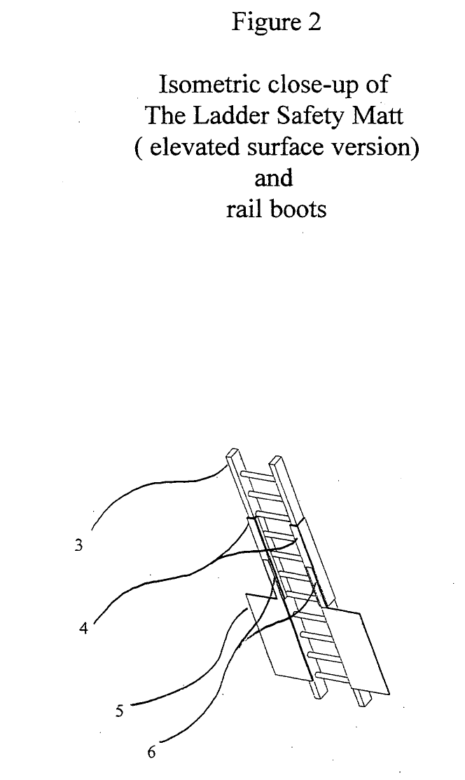

FIG. 2 shows an isometric close-up view of The Ladder Safety Matt (elevated surface version) (5) along with the connecting straps (6), which connect them to the rail boots (4). The rail boots (4) are attached to the extension ladder's (3) rails at the area where the rails rest against the building's (8) surface.

Both the Ladder Safety Matt (5) and the rail boots (4) are made of slip resistant rubber and provide protection to surfaces contacted.

The rail boots (4) are a few feet long and this embodiment covers three sides of the rail: the outside, the contacting surface against the building and part of the inside up to the steps. The rail boots can be fastened to the rail with straps or hooks or velcro.

The Ladder safety Matts (5) are shown flattened out here but during storage and handling, they are rolled up and fastened against the rail boots until needed.

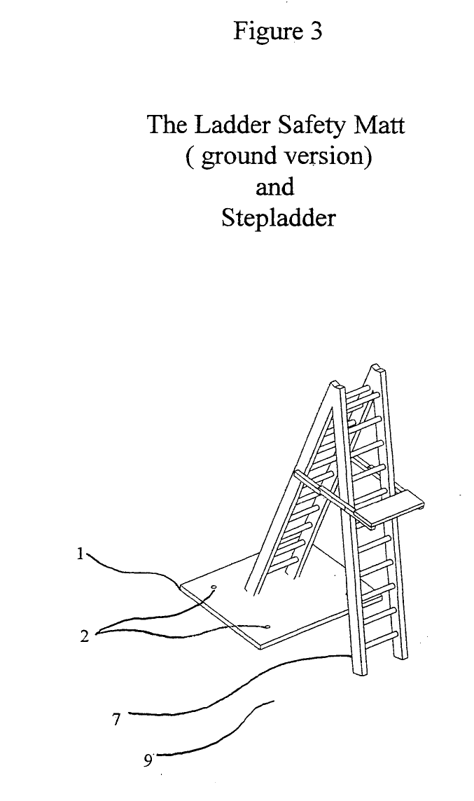

FIG. 3 shows a stepladder (7) in an open and used position where the Ladder Safety Matt (ground version) (1) is being used to support two of the legs of the stepladder (7). For even more safety, a second Ladder Safety Matt (1) may be used for the other two legs.

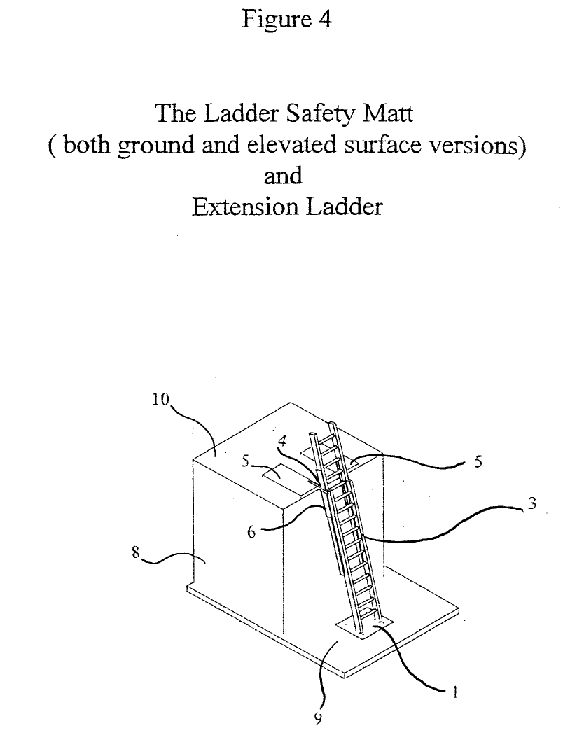

FIG. 4 shows an extension ladder (3) being used against a building (8), where the two legs of the ladder (3) are propped upon the Ladder Safety Matt (ground version) (1), and where the rails leaning against the building (8) are covered with the rail boots (4) and the Ladder Safety Matts (elevated version) (5) are laid out upon the roof surface (10), providing slip proofing and additional frictional holding of the ladder (3) in it's place via the connecting straps (6) from the Matts (5) to the rail boots (4).

### OPERATION OF INVENTION

The Ladder Safety Matt Invention comprises of The Ladder Safety Matt (ground version) (1), rail boots (4), The Ladder Safety Matts (elevated surface version) (5) and connecting straps (6).

For stepladder applications, one simply unrolls the ladder safety matt (ground version) (1) and lays it at the area where the stepladder (7) is needed. Then one places two legs of the stepladder (7) on the matt (1), whereby the weight of the stepladder (7) and the person using it form an indentation into the rubber of the matt (1). If the matt (1) is on grass or sand, one may drive some stakes through the matt (1) at the holes (2) provided, for added security.

For extension ladder (3) applications, again, one simply unrolls the ladder safety matt (1) (ground version) and lays it at the area where the extension ladder (3) is needed.

At the upper end of the extension ladder (3), centering about three feet from the very top of the ladder (3), the rails boots (4) are installed before raising the ladder (3) against the building (8) and the ladder safety matts (elevated surface version) (5) are rolled up and connected to the rail boots (4) with the connecting straps (6).

The ladder (3) is then raised into position and the two legs of the ladder (3) are propped on the matt (1), whereby the weight of the ladder (3) and the person using it form an indentation into the rubber of the matt (1). If the matt (1) is on grass or sand, one may drive some stakes through the matt (1) at the holes (2) provided, for added security.

The upper end of the ladder (3) is leaned against the building (8) at the area of the rail boots (4), providing slip proofing and protecting the surface areas being contacted on the building (8). The ladder (1) extends approximately three feet above the top of the building (8).

One proceeds to climb the ladder (3), and when he gets to the area of the rail boots (4), he unfurls the ladder safety matts (elevated surface version) (5) and flops them onto the surface of the roof (10). They provide additional frictional holding power to the ladder (3) by being connected via the connecting straps (6) to the rail boots (4). As well as providing a slip proof stepping surface for climbing onto the roof (10) off the ladder (3). The rubber of the matts (5) is pliable and soft and adhesive-like for good holding power and ease of management.

Then, for coming down the ladder (3) off the roof (10), one steps onto the safety matt (5) and grabs the top of the extension ladder (3) and proceeds downward and when he gets to the level where he can reach the matts (5), he peels them off the roof (110) and lets them hang on the side of the ladder (3). He can roll them back up when he is safely on the ground.

### CONCLUSIONS, RAMIFICATIONS AND SCOPE OF INVENTION

Thus the reader will see that The Ladder Safety Matt Invention provides enhanced safety whenever a ladder is used.

While my above description contains many specificities, these should not be construed as limitations on the scope of the invention, but rather, as exemplifications of preferred embodiments thereof. Other variations are possible.

Accordingly, the scope of the invention should be determined not by the embodiments illustrated, but by the appended claims and their legal equivalents.

1- A device for providing extra traction when using ladders comprising:
(a) a ground version ladder safety matt used at the area needed to place the feet of a ladder,
(b) for an extension ladder, rail boots that attach at the area of said ladder where it makes contact to a building surface, approximately centered three feet from the top of said ladder,
(c) an elevated surface version ladder safety matt that lays out onto the roof or top of said building where said extension ladder is leaned upon and where connecting straps hold said ladder to said elevated surface version safety matts,
whereby the area upon which said ladder is leaned upon would have protected contact of said rail boots,
whereby said rail boots provide added gripping power at area where said extension ladder leans upon said building,
whereby an additional friction is created by said elevated safety matts helping to keep said ladder in place via said connecting straps,
whereby a slip-proof surface is provided by said elevated safety matts for climbing onto or down from said roof or top of building.

2- The device of claim 1, whereby both ground and elevated surface versions of said ladder safety matts are made of materials that provide a means for slip-proofing such as rubber.

3- The device of claim 1, whereby said material is soft enough to indent whenever said ladder feet are placed on it.

4- The device of claim 1, whereby said ground version matt has holes that allow for ground stakes to be driven through it when placed on grass, earth or sand.

5- The device of claim 1, whereby materials used for said device be lightweight.

6- A method for enhancing ladder safety, comprising the steps of:
(a) laying out the ground version ladder safety matt at the area needed to place the feet of a ladder,
(b) for an extension ladder, attaching the rail boots at the area of said ladder where it makes contact to a building surface, where said area is usually centered approximately three feet from the top of said ladder,
(c) laying out elevated surface version ladder safety matts onto the roof or top of said building where said extension ladder is leaned upon and where connecting straps hold said ladder to said elevated surface version safety matts,
whereby said area upon which said ladder is leaned upon would have the protected contact of said rail boots,
whereby said rail boots provide added gripping power at said area where said extension ladder leans upon said building,
whereby the additional friction created by said elevated surface version safety matt helps keep said ladder in place via said connecting straps,
whereby a slip proof surface is provided by said elevated safety matt for climbing onto or down from said roof or top of building.

7- The method of claim 6, whereby both ground and elevated surface versions of said ladder safety matts are made of materials that provide a means for slip-proofing such as rubber.

8- The method of claim 6, whereby said material is soft enough to indent whenever said ladder feet are placed on it.

9- The method of claim 6, whereby said ground version matt has holes that allow for ground stakes to be driven through it when placed on grass, earth or sand.

10- The method of claim 6, whereby materials used for said device be lightweight.
